(19) United States
(12) Patent Application Publication
(10) Pub. No.: US 2026/0223137 A1
(43) Pub. Date: Jul. 30, 2026

(54) METHOD PERFORMED BY USER EQUIPMENT, AND USER EQUIPMENT

(71) Applicant: Sharp Kabushiki Kaisha, Sakai City, Osaka (JP)

(72) Inventors: Yinan ZHAO, Shanghai (CN); Chao LUO, Shanghai (CN); Renmao LIU, Shanghai (CN)

(21) Appl. No.: 19/145,538

(22) PCT Filed: Dec. 29, 2023
(86) PCT No.: PCT/CN2023/143215

§ 371 Date: Jul. 3, 2025

(30) Foreign Application Priority Data
Jan. 9, 2023 (CN) 202310030028.9

(51) Int. Cl. H04W 72/25

(52) U.S. Cl. CPC H04W 72/25

(57) ABSTRACT

The present invention provides a method performed by user equipment, and user equipment. The method includes: requesting or triggering, by a higher layer, the user equipment to determine a resource subset for PSSCH/PSCCH transmission; determining a candidate resource set; and excluding one or more candidate resources from the candidate resource set, the user equipment being sidelink user equipment equipped with both an LTE sidelink module and an NR sidelink module.

### TECHNICAL FIELD

The present invention relates to the technical field of wireless communications, and in particular to a method performed by user equipment, and corresponding user equipment.

### BACKGROUND ART

In conventional cellular networks, all communication needs to pass through base stations. By contrast, D2D communication (device-to-device communication, device-to-device direct communication) refers to a direct communication method between two user equipment units without forwarding via a base station or a core network. A research project on the use of LTE equipment to implement proximity D2D communication services was approved at the 3rd Generation Partnership Project (3GPP) RAN #63 plenary meeting in March 2014 (see Non-Patent Document 1). Functions introduced in the LTE Release 12 D2D include:
1) a discovery function between proximate devices in an LTE network coverage scenario;
2) a direct broadcast communication function between proximate devices; and
3) support for unicast and groupcast communication functions at higher layers.

A research project on enhanced LTE eD2D (enhanced D2D) was approved at the 3GPP RAN #66 plenary meeting in December 2014 (see Non-Patent Document 2). The main functions introduced in the LTE Release 13 eD2D include:
1) D2D discovery in out-of-coverage and partial-coverage scenarios; and
2) a priority handling mechanism for D2D communication.

Based on the design of the D2D communication mechanism, a V2X feasibility research project based on D2D communication was approved at the 3GPP RAN #68 plenary meeting in June 2015. V2X stands for Vehicle to Everything, and is used to implement information exchange between a vehicle and all entities that may affect the vehicle, for the purpose of reducing accidents, alleviating traffic congestion, reducing environmental pollution, and providing other information services. Application scenarios of V2X mainly include four aspects:
1) V2V, Vehicle to Vehicle, i.e., vehicle-to-vehicle communication;
2) V2P, Vehicle to Pedestrian, i.e., a vehicle transmits alarms to a pedestrian or a non-motorized vehicle;
3) V2N: Vehicle-to-Network, i.e., a vehicle connects to a mobile network;
4) V2I: Vehicle-to-Infrastructure, i.e., communication such as that between a vehicle and road infrastructure.

3GPP divides the research and standardization of V2X into three stages. The first stage was completed in September 2016, and mainly focused on V2V and was based on LTE Release 12 and Release 13 D2D (also known as sidelink), that is, the development of proximity communication technologies (see Non-Patent Document 3). V2X stage 1 introduces a new D2D communication interface referred to as a PC5 interface. The PC5 interface is mainly used to address the issue of cellular Internet of Vehicle (IoV) communication in high-speed (up to 250 km/h) and high-node-density environments. Vehicles can exchange information such as position, speed, and direction through the PC5 interface, that is, the vehicles can communicate directly through the PC5 interface. Compared with the proximity communication between D2D devices, the functions introduced in LTE Release 14 V2X mainly include:
1) higher density DMRS to support high-speed scenarios;
2) introduction of sub-channels to enhance resource allocation methods; and
3) introduction of a user equipment sensing mechanism having semi-persistent scheduling.

The second stage of the V2X research project belongs to the LTE Release 15 research category (see Non-Patent Document 4). The introduced main features include high-order 64QAM modulation, V2X carrier aggregation, and short TTI transmission, and also include feasibility study on transmit diversity.

The corresponding third stage, a V2X feasibility research project based on 5G NR network technologies (see Non-Patent Document 5), was approved at the 3GPP RAN #80 plenary meeting in June 2018.

In the 5G NR V2X project, user equipment sensing-based resource allocation mode 2, or referred to as transmission mode 2, is supported. For the user equipment sensing-based resource allocation mode 2, the physical layer of the user equipment senses transmission resources in a resource pool, which indicates that the user equipment, according to indication information in received SCI transmitted by another user equipment, determines whether to exclude a resource that is in a candidate resource set and that overlaps with a resource indicated by the indication information, and resources that are not excluded from the candidate resource set are reported to a higher layer.

A standardization study project based on standardized NR sidelink evolution (abbreviated as NR SL evo) was approved at the 3GPP RAN #95e plenary meeting in March 2022 (see Non-Patent Document 6). The research objectives of NR SL evo include the following aspect:
1) studying and standardizing LTE sidelink and NR sidelink co-channel (or carrier) coexistence, that is, a scenario in which communication frequencies of an LTE sidelink and an NR sidelink are the same or overlapping. For the LTE sidelink device and the NR sidelink device that use a common communication frequency, an effective resource allocation mode is designed so as not to affect the communication of the two sidelink devices.

The solutions of the present patent mainly include a method for excluding a candidate resource from a candidate resource set by NR sidelink user equipment, or a method for performing resource selection (or re-selection) by the NR sidelink user equipment, in an LTE sidelink and NR sidelink co-channel scenario.

### PRIOR ART DOCUMENT

### Non-Patent Documents

Non-Patent Document 1: RP-140518, Work item proposal on LTE Device to Device Proximity Services
Non-Patent Document 2: RP-142311, Work Item Proposal for Enhanced LTE Device to Device Proximity Services
Non-Patent Document 3: RP-152293, New WI proposal: Support for V2V services based on LTE sidelink
Non-Patent Document 4: RP-170798, New WID on 3GPP V2X Phase 2
Non-Patent Document 5: RP-181480, New SID proposal: Study on NR V2X
Non-Patent Document 6: RP-220300, WID revision: NR sidelink evolution

### SUMMARY OF THE INVENTION

In order to address at least part of the aforementioned issues, the present invention provides a method performed by user equipment, and user equipment.

A method performed by user equipment according to a first aspect of the present invention comprises: requesting or triggering, by a higher layer, the user equipment to determine a resource subset for PSSCH/PSCCH transmission; determining a candidate resource set; and excluding one or more candidate resources from the candidate resource set, the user equipment being sidelink user equipment equipped with both an LTE sidelink module and an NR sidelink module.

According to the method of the first aspect of the present invention, the higher layer selects a sidelink resource for the PSSCH/PSCCH transmission in the resource subset.

According to the method of the first aspect of the present invention, the higher layer, in a slot n, requests the user equipment to determine the resource subset for the PSSCH/PSCCH transmission.

According to the method of the first aspect of the present invention, the candidate resource set represents candidate resources in a resource selection window [n+T₁, n+T₂].

According to the method of the first aspect of the present invention, the user equipment excludes one or more candidate resources from the candidate resource set based on a parameter Q, the parameter Q representing the number of SCIs that the user equipment assumes to be received and that are the same as SCIs received by the LTE sidelink module on a subframe

$${t}_{m}^{SL} .$$

According to the method of the first aspect of the present invention, if P_{rsvp_RX}×Pₛₜₑₚ<T₂ and n′−m≤Pₛₜₑₚ×P_{rsvp_RX}, Q=┌T₂/(P_{rsvp_RX}×Pₛₜₑₚ)┐; otherwise, Q=1. P_{rsvp_RX} represents a resource reservation interval indicated in the SCIs received by the LTE sidelink module on the subframe

$${t}_{m}^{SL} ,$$

and if the slot n belongs to a subframe set

$$( {t}_{0}^{SL} , {t}_{1}^{SL} , … , {t}_{{T}_{max}}^{SL} ) , {t}_{{n}^{′}}^{SL} = n ;$$

otherwise,

$${t}_{{n}^{′}}^{SL}$$

represents the first subframe, following the slot n, that belongs to the subframe set

$$( {t}_{0}^{SL} , {t}_{1}^{SL} , … , {t}_{{T}_{max}}^{SL} ) .$$

Pₛₜₑₚ represents the number of uplink subframes available in Pₛₑᵣᵥ based on LTE sidelink TDD configuration information; and LTE V2X includes a period of service generation: Pₛₑᵣᵥ=100 ms.

According to the method of the first aspect of the present invention, the LTE sidelink module of the user equipment indicates or shares information associated with the SCIs to the NR sidelink module, including: the SCIs received by the LTE sidelink module on the subframe

$${t}_{m}^{SL} ;$$

and/or the resource reservation interval or period P_{rsvp_RX} indicated in the SCIs received by the LTE sidelink module on the subframe

$${t}_{m}^{SL} ;$$

and/or the LTE sidelink TDD configuration information.

According to the method of the first aspect of the present invention, the user equipment excluding one or more candidate resources from the candidate resource set based on a parameter Q further includes: at least satisfying that, if resource blocks and subframe resources indicated in the SCIs received by the LTE sidelink module on the subframe

$${t}_{m}^{SL}$$

or the same SCIs assumed to be received on the subframe

$${t}_{m + q \times {P}_{step} \times {P}_{rsvp \_ RX}}^{SL}$$

overlap with a candidate single subframe resource

$${R}_{x , y + j \times {P}_{{rsvp \_ TX}^{′}}} ,$$

the user equipment excludes the candidate single subframe resource R_{x,y} from the candidate resource set, where q=1, 2, . . . , Q, and j=1, 2, . . . , Cᵣₑₛₑₗ−1;

$${P}_{{rsvp \_ TX}^{′}} = {P}_{{rsvp}_{- TX}} \times {P}_{step} / 100 or {P}_{{rsvp \_ TX}^{′}} = ⌈ \frac{{T}_{max}^{′}}{10240 ms} \times {P}_{{rsvp}_{- TX}} ⌉ ;$$

P_{rsvp_TX} represents a resource reservation interval or period sent by the user equipment; and Tₘₐₓ′ represents the number of slots or subframes in the resource pool within 10240 ms.

According to the method of the first aspect of the present invention, the user equipment assumes that, in the SCIs and the same SCIs, an indication field of a time gap between initial transmission and retransmission is equal to 0.

User equipment according to a second aspect of the present invention comprises: a processor; and a memory storing instructions, the instructions, when run by the processor, perform the method according to any implementation of the first aspect.

### BENEFICIAL EFFECTS OF PRESENT INVENTION

According to the solution of the present patent, in a scenario with LTE sidelink and NR sidelink co-channel coexistence, it can be ensured that the transmission resource selected by the NR sidelink user equipment does not overlap or conflict with the transmission resource for the LTE sidelink, which can improve the reliability of the NR sidelink while effectively reducing the impact on the existing LTE sidelink system (i.e., reducing interference).

### BRIEF DESCRIPTION OF THE DRAWINGS

The above and other features of the present invention will be more apparent from the following detailed description in combination with the accompanying drawings, in which:

FIG. 1 is a schematic diagram showing a basic procedure of a method performed by user equipment according to Embodiment 1 of the present invention.

FIG. 2 is a block diagram showing user equipment according to an embodiment of the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

In the following description, a 5G mobile communication system and later evolved versions thereof are used as exemplary application environments to set forth a plurality of embodiments according to the present invention in detail. However, it is to be noted that the present invention is not limited to the following embodiments, but is applicable to many other wireless communication systems, such as a communication system after 5G and a 4G mobile communication system before 5G.

Some terms involved in the present invention are described below. Unless otherwise specified, the terms used in the present invention use the definitions herein. The terms given in the present invention may vary in LTE, LTE-Advanced, LTE-Advanced Pro, NR, and subsequent communication systems, but unified terms are used in the present invention. When applied to a specific system, the terms may be replaced with terms used in the corresponding system.
3GPP: 3rd Generation Partnership Project
LTE: Long Term Evolution
NR: New Radio
PDCCH: Physical Downlink Control Channel
DCI: Downlink Control Information
PDSCH: Physical Downlink Shared Channel
UE: User Equipment
eNB: evolved NodeB, evolved base station
gNB: NR base station
TTI: Transmission Time Interval
OFDM: Orthogonal Frequency Division Multiplexing
CP-OFDM: Cyclic Prefix Orthogonal Frequency Division Multiplexing
C-RNTI: Cell Radio Network Temporary Identifier
CSI: Channel State Information
HARQ: Hybrid Automatic Repeat Request
CSI-RS: Channel State Information Reference Signal
CRS: Cell Reference Signal
PUCCH: Physical Uplink Control Channel
PUSCH: Physical Uplink Shared Channel
UL-SCH: Uplink Shared Channel
CG: Configured Grant
Sidelink: sidelink
SCI: Sidelink Control Information
PSCCH: Physical Sidelink Control Channel
MCS: Modulation and Coding Scheme
RB: Resource Block
RE: Resource Element
CRB: Common Resource Block
CP: Cyclic Prefix
PRB: Physical Resource Block
PSSCH: Physical Sidelink Shared Channel
FDM: Frequency Division Multiplexing
RRC: Radio Resource Control
RSRP: Reference Signal Receiving Power
SRS: Sounding Reference Signal
DMRS: Demodulation Reference Signal
CRC: Cyclic Redundancy Check
PSDCH: Physical Sidelink Discovery Channel
PSBCH: Physical Sidelink Broadcast Channel
SFI: Slot Format Indication
TDD: Time Division Duplexing
FDD: Frequency Division Duplexing
SIB1: System Information Block Type 1
SLSS: Sidelink Synchronization Signal
PSSS: Primary Sidelink Synchronization Signal
SSSS: Secondary Sidelink Synchronization Signal
PCI: Physical Cell ID
PSS: Primary Synchronization Signal
SSS: Secondary Synchronization Signal
BWP: Bandwidth Part
GNSS: Global Navigation Satellite System
SFN: System Frame Number (radio frame number)
DFN: Direct Frame Number
IE: Information Element
SSB: Synchronization Signal Block
EN-DC: EUTRA-NR Dual Connection, LTE-NR Dual Connectivity
MCG: Master Cell Group
SCG: Secondary Cell Group
PCell: Primary Cell
SCell: Secondary Cell
PSFCH: Physical Sidelink Feedback Channel
SPS: Semi-Persistent Scheduling
TA: Timing Advance
PT-RS: Phase-Tracking Reference Signal
TB: Transport Block
CB: Code Block
QPSK: Quadrature Phase Shift Keying
16/64/256 QAM: 16/64/256 Quadrature Amplitude Modulation
AGC: Automatic Gain Control
TDRA (field): Time Domain Resource Assignment indication (field)
FDRA (field): Frequency Domain Resource Assignment indication (field)
ARFCN: Absolute Radio Frequency Channel Number
SC-FDMA: Single Carrier-Frequency Division Multiple Access
MAC: Medium Access Control
DRX: Discontinuous Reception

The following is a description of the prior art associated with the solution of the present invention. Unless otherwise specified, the same terms in the specific embodiments have the same meanings as in the prior art.

It is worth pointing out that the V2X and sidelink mentioned in the description of the present invention have the same meaning. The V2X herein can also mean sidelink; similarly, the sidelink herein can also mean V2X, and no specific distinction and limitation will be made in the following text.

The resource allocation mode of V2X (sidelink) communication and the transmission mode of V2X (sidelink) communication in the description of the present invention can equivalently replace each other. The resource allocation mode involved in the description can mean a transmission mode, and the transmission mode involved herein can mean a resource allocation mode. In NR sidelink, transmission mode 1 represents a base station scheduling-based transmission mode (resource allocation mode); and transmission mode 2 represents a user equipment sensing-based and resource selection-based transmission mode (resource allocation mode).

The PSCCH in the description of the present invention is used to carry SCI. The PSSCH associated with or relevant to or corresponding to or scheduled by PSCCH involved in the description of the present invention has the same meaning, and all refer to an associated PSSCH or a corresponding PSSCH. Similarly, the SCI (including first stage SCI and second stage SCI) associated with or related to or corresponding to PSSCH involved in the description has the same meaning, and all refer to associated SCI or corresponding SCI. It is worth pointing out that the first stage SCI, referred to as 1st stage SCI or SCI format 1-A, is transmitted in the PSCCH, and the second stage SCI, referred to as 2^{nd} stage SCI or SCI format 2-A (or SCI format 2-B), is transmitted on a resource of the corresponding PSSCH.

### Numerologies in NR (Including NR Sidelink) and Slots in NR (Including NR Sidelink)

A numerology includes two aspects: a subcarrier spacing and a cyclic prefix (CP) length. NR supports five subcarrier spacings, which are 15 kHz, 30 kHz, 60 kHz, 120 kHz, and 240 kHz, respectively (corresponding to μ=0,1,2,3,4). Table 4.2-1 shows the supported transmission numerologies, specifically as follows.

TABLE 4.2-1
Subcarrier Spacings Supported by NR

| | Δf = 2^{μ} · 15 | |
|---|---|---|
| μ | [kHz] | CP (cyclic prefix) |
| 0 | 15 | Normal |
| 1 | 30 | Normal |
| 2 | 60 | Normal, extended |
| 3 | 120 | Normal |
| 4 | 240 | Normal |

Only when μ=2, namely, in the case of a 60 kHz subcarrier spacing, is the extended CP supported, and only the normal CP is supported in the case of other subcarrier spacings. For the normal CP, each slot includes 14 OFDM symbols; for the extended CP, each slot includes 12 OFDM symbols. For μ=0, namely, a 15 kHz subcarrier spacing, one slot=1 ms; for μ=1, namely, a 30 kHz subcarrier spacing, one slot=0.5 ms; for μ=2, namely, a 60 kHz subcarrier spacing, one slot=0.25 ms, and so on.

NR and LTE have the same definition for a subframe, which denotes 1 ms. For a subcarrier spacing configuration μ, a slot index in one subframe (1 ms) may be expressed as

$${n}_{s}^{μ} ,$$

and ranges from 0 to

$${N}_{slot}^{subframe , μ} - 1.$$

A slot index in one system frame (a duration of 10 ms) may be expressed as

$${n}_{s , f}^{μ} ,$$

and ranges from 0 to

$${N}_{slot}^{frame , μ} - 1.$$

The definitions of

$${N}_{slot}^{subframe , μ} and {N}_{slot}^{frame , μ}$$

in different cases of subcarrier spacings μ are shown in the tables below.

TABLE 4.3.2-1
the number of symbols included in each slot, the number of slots included
in each system frame, and the number of slots included in each subframe
for the normal CP

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4.3.2-2
the number of symbols included in each slot, the number of slots included
in each system frame, and the number of slots included in each subframe
for the extended CP (60 kHz)

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

On an NR carrier, a system frame (or simply referred to as frame) number (SFN) ranges from 0 to 1023. The concept of a direct system frame number (DFN) is introduced to sidelink, and the number thereof likewise ranges from 0 to 1023. The above description of the relationship between the system frame and numerology can also be applied to a direct system frame. For example, the duration of one direct system frame is likewise equal to 10 ms; for a 15 kHz subcarrier spacing, one direct system frame includes 10 slots, and so on. The DFN is applied to timing on a sidelink carrier.

### Parameter Sets in LTE (Including LTE V2X) and Slots and Subframes in LTE (Including LTE V2X)

The LTE only supports a 15 kHz subcarrier spacing. Both the extended CP and the normal CP are supported in the LTE. The subframe has a duration of 1 ms and includes two slots. Each slot has a duration of 0.5 ms.

For a normal CP, each subframe includes 14 OFDM symbols, and each slot in the subframe includes 7 OFDM symbols; for an extended CP, each subframe includes 12 OFDM symbols, and each slot in the subframe includes 6 OFDM symbols.

### Resource Block (RB) and Resource Element (RE)

The resource block (RB) is defined in the frequency domain as

$${N}_{sc}^{RB} = 12$$

consecutive subcarriers. For example, for a 15 kHz subcarrier spacing, the RB is 180 kHz in frequency domain. For a subcarrier spacing 15 kHz×2^{μ}, the resource element (RE) represents one subcarrier in the frequency domain and one OFDM symbol in the time domain.

### Sidelink Communication Scenario

1) Out-of-coverage sidelink: both of two UEs performing sidelink communication are out of network coverage (for example, the UE cannot detect any cell that meets a “cell selection criterion” on a frequency at which sidelink communication needs to be performed, meaning the UE is out of network coverage).
2) In-coverage sidelink: both of two UEs performing sidelink communication are in network coverage (for example, the UE detects at least one cell that meets a “cell selection criterion” on a frequency at which sidelink communication needs to be performed, meaning the UE is in network coverage).
3) Partial-coverage sidelink: one of two UEs performing sidelink communication is out of network coverage, and the other is in network coverage.

From the perspective of the UE side, the UE only has two scenarios, out-of-coverage and in-coverage. Partial-coverage is described from the perspective of sidelink communication.

### Sidelink Resource Pool

In sidelink, resources transmitted and received by UE all belong to resource pools. For example, for a base station scheduling-based transmission mode in sidelink, the base station schedules transmission resources for sidelink UE in a resource pool; alternatively, for a UE sensing-based transmission mode in sidelink, the UE determines a transmission resource in a resource pool.

The numeral

$${t}_{y}^{SL}$$

in the specification of the present invention represents a subframe (or a slot) that may belong to a sidelink resource pool, that is, a subframe (or slot) set obtained before resource pool configuration information (a bitmap) is applied. The numeral

$${t}_{y}^{′ SL}$$

represents a slow (or a subframe) in a sidelink resource pool, that is, a slot (or subframe) set obtained after resource pool configuration information (a bitmap) is applied.

### Sensing-Based Resource Allocation Mode (Resource Allocation Mode 2)

For a resource allocation mode based on sensing, sidelink user equipment selects a candidate resource within one time window; determines, according to a reserved resource indicated by a PSCCH transmitted by another user equipment in a monitoring slot, candidate resources overlapping with the reserved resource; and excludes said candidate resources overlapping the reserved resource. The physical layer reports, to the MAC layer, a set of candidate resources that are not excluded, and the MAC layer selects transmission resources for the PSSCH/PSCCH. The set of the transmission resources selected by the MAC layer is referred to as a selected sidelink grant.

The resource allocation mode based on sensing (full sensing) means that the set of slots monitored by the user equipment consists of consecutive slots in a monitoring window (sensing window).

Resource Selection Window [n+T1, n+T2]

In a resource allocation mode based on sensing (or, partial sensing), a higher layer requests or triggers, in a slot n, the physical layer to determine a resource for PSSCH/PSCCH transmission (to perform sensing or partial sensing). The resource selection window is defined as [n+T1, n+T2]. That is, user equipment selects a transmission resource within the foregoing window. T1 satisfies the condition

$$0 \leq T 1 \leq {T}_{proc , 1}^{SL} ,$$

and the selection of T1 is up to user equipment implementation. RRC configuration information includes a resource selection window configuration list sl-SelectionWindowList, and an element in the list and corresponding to a given priority prio_{TX} (a priority of transmitting the PSSCH) is represented by T₂ₘᵢₙ. If T₂ₘᵢₙ is less than a remaining packet delay budget (PDB), T2 satisfies the condition T₂ₘᵢₙ≤T2≤remaining PDB, and the selection of T2 is up to user equipment implementation; otherwise, T2 is set to the remaining PDB.

$${T}_{proc , 1}^{SL}$$

is defined as follows (μ_{SL} represents a sidelink subcarrier spacing parameter, that is, the subcarrier spacing is 2^{μ}^{_{SL}}×15 kHz):

TABLE 8.1.4-2
$Values of {T}_{p r o c , 1}^{SL}$

| μ_{SL} | ${T}_{p r o c , 1}^{SL} [ slots ]$ |
|---|---|
| 0 | 3 |
| 1 | 5 |
| 2 | 9 |
| 3 | 17 |

TABLE 8.1.4-1
$Values of {T}_{p r o c , 0}^{SL}$

| μ_{SL} | ${T}_{p roc , 0}^{SL} [ slots ]$ |
|---|---|
| 0 | 1 |
| 1 | 1 |
| 2 | 2 |
| 3 | 4 |

Sidelink User Equipment with Dual Modules

In a scenario with LTE sidelink and NR sidelink co-channel co-existence, at least sidelink user equipment equipped with both an LTE sidelink module and an NR sidelink module is supported, that is, the sidelink user equipment can not only perform the transmission and reception functions of the LTE sidelink, but can also perform the transmission and reception functions of the NR sidelink. It should be noted that, in this type of user equipment, the LTE sidelink module may share (or indicate) information to the NR sidelink module; the information may be resource reservation information of the LTE sidelink, sensing information, or the like. The NR sidelink module may also acquire resource pool configuration information of the LTE sidelink, configuration information of the LTE sidelink SLSS, etc., including, but not limited to, the above information, without the need for sharing (or indicating) by the LTE sidelink module.

### Method for LTE V2X UE to Determine a PSSCH Subframe Resource Pool

In LTE V2X, a method for determining a subframe resource pool is based on all subframes in a range of SFN #0 to SFN #1023, a total of 10240 subframes. Herein, a subframe set that may belong to a PSSCH subframe resource pool transmitted by V2X UE is represented as

$$( {t}_{0}^{SL} , {t}_{1}^{SL} , … , {t}_{{T}_{max}}^{SL} ) ,$$

which satisfies:
1)

$$0 \leq {t}_{i}^{SL} < 10240 ,$$

2) subframes in the above subframe set are numbered relative to subframe #0 of SFN #0 or DFN #0, namely, a subframe for which

$${t}_{i}^{SL} = 0$$

corresponds to subframe #0 of SFN #0 or DFN #0;
3) the above subframe set includes all subframes after the following subframes (subframes included in a, b, and c) are excluded:
   a) subframes configured with an SLSS, the number of which is represented as N_{SLSS};
   b) downlink subframes and special subframes in a TDD cell, the number of which is represented as N_{dssf};
   c) reserved subframes, a method for determining the reserved subframes being:
      After N_{SLSS} and N_{dssf} subframes are excluded from all subframes with subframe numbers 0-10239, the remaining (10240−N_{SLSS}−N_{dssf}) subframes are arranged in ascending order of subframe numbers, which may be represented herein as (l₀, l₁, . . . , l_{0240-N}_{_{SLSS}}_{-N}_{_{dssf}}₋₁). r=floor(m·(10240−N_{SLSS}−N_{dssf})/N_{reserved}). m=0, 1, . . . , N_{reserved}−1, and N_{reserved}=(10240−N_{SLSS}−N_{dssf})mod L_{bitmap}. L_{bitmap} represents the length of a bitmap configured for the resource pool, and is configured by an upper layer. The bitmap may be represented as (b₀, b₁, . . . , b_{L}_{_{bitmap}}₋₁). A subframe indexed corresponding to the subframe l, is a reserved subframe.
4) the subframes in the subframe set are arranged in ascending order of subframe numbers.

A method used by the UE to determine the PSSCH subframe resource pool is as follows: For subframe

$${t}_{k}^{SL}$$

in the subframe set

$$( {t}_{0}^{SL} , {t}_{1}^{SL} , … , {t}_{{T}_{max}}^{SL} ) ,$$

if bₖ′=1, where k′=k mod L_{bitmap}, then subframe

$${t}_{k}^{SL}$$

belongs to the PSSCH subframe resource pool.

### Reserved Resource for LTE V2X Transmission Mode 4

In LTE V2X transmission mode 4, when UE determines resources for sidelink communication transmission through a sensing procedure, the UE reserves resources for periodic traffic data. Assuming that a subframe resource determined by the UE for transmitting a PSSCH is represented as subframe

$${t}_{m}^{SL} ,$$

then the UE reserves the resource on subframe

$${t}_{m + j \times {P}_{{rsvp \_ TX}^{′}}}^{SL} .$$

$$j = 1 , 2 , … , {C}_{resel} - 1 , {C}_{resel} = 10 \times SL\_RESOURCE \_RESELECTION \_COUNTER ,$$

and SL_RESOURCE_RESELECTION_COUNTER is configured by a higher layer. If the higher layer does not configure the parameter, then Cᵣₑₛₑₗ=1. P_{rsvp_TX′}=Pₛₜₑₚ×P_{rsvp_TX}/100. LTE V2X includes a periodic service, and the period of service generation is approximately Pₛₑᵣᵥ=100 ms. Pₛₜₑₚ represents the number of uplink subframes available in Pₛₑᵣᵥ. The following Table 1 shows the values of Pₛₜₑₚ in different TDD uplink and downlink configuration information in LTE V2X. For example, for TDD UL/DL configuration information 2, each system frame includes two uplink subframes. In a service period of Pₛₑᵣᵥ=100 ms, there are a total of 20 uplink subframes. Table 1 shows determination of Pₛₜₑₚ for edge connection transmission modes 3 and 4, as shown in the following table for details.

TABLE 1
Determination of Pₛₜₑₚ

| | Pₛₜₑₚ |
|---|---|
| TDD UL/DL configuration information 0 | 60 |
| TDD UL/DL configuration information 1 | 40 |
| TDD UL/DL configuration information 2 | 20 |
| TDD UL/DL configuration information 3 | 30 |
| TDD UL/DL configuration information 4 | 20 |
| TDD UL/DL configuration information 5 | 10 |
| TDD UL/DL configuration information 6 | 50 |
| Other | 100 |

P_{rsvp_TX} represents a resource reservation interval indicated by an upper layer.

### Determination of Resource Reservation Indication Field in SCI Format 1 Performed by LTE V2X UE

A resource reservation interval indicated by an upper layer is represented as P_{rsvp_TX}. UE determines the value of X=P_{rsvp_TX}/100 according to the indication of the upper layer, and in conjunction with the following Table 2, the UE can determine a resource reservation indication field (4-bit indication field) in SCI.

TABLE 2

| Resource reservation | | |
|---|---|---|
| indication field in SCI | X | Specific description |
| ‘0001’, ‘0010’, . . . , | Value of the indication | 1 ≤ X ≤ 10 |
| ‘1010’ | field in SCI | |
| ‘1011’ | 0.5 | X = 0.5 |
| ‘1100’ | 0.2 | X = 0.2 |
| ‘0000’ | 0 | The upper layer |
| | | indicates no reserved |
| | | resources |
| ‘1101’, ‘1110’, ‘1111’ | Reserved value | |

### Initial Transmission and Blind Retransmission in LTE V2X

In LTE V2X, at most one blind retransmission is supported, that is, the user equipment may send an initial transmission and one retransmission, or may send only the initial transmission. When a transmission of a TB includes a blind retransmission, a value of an indication field of “time gap between initial transmission and retransmission” is not equal to 0; or when a transmission of a TB does not include a retransmission, a value of an indication field of “time gap between initial transmission and retransmission” is equal to 0.

### Candidate Single Subframe (Slot) Resource R_{x,y}

It is assumed that the number of sub-channels for transmitting a PSSCH by sidelink user equipment is L_{subCH}·R_{x,y} represents L_{subCH} consecutive sub-channels (sub-channel x to sub-channel x+L_{subcH}−1) on a subframe

$${t}_{y}^{SL} ,$$

or R_{x,y} represents L_{subCH} consecutive sub-channels (sub-channel x to sub-channel x+L_{subCH}−1) on a subframe

$${t}_{y}^{′ SL} .$$

Hereinafter, specific examples and embodiments related to the present invention are described in detail. In addition, as described above, the examples and embodiments described in the present disclosure are illustrative descriptions for facilitating understanding of the present invention, rather than limiting the present invention.

### Embodiment 1

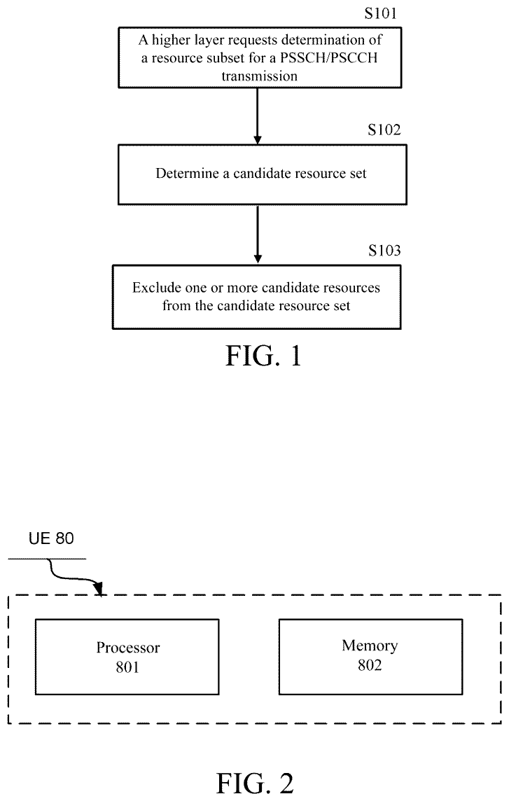

FIG. 1 is a schematic diagram showing a basic procedure of a method performed by user equipment according to Embodiment 1 of the present invention.

The method performed by user equipment according to Embodiment 1 of the present invention is described in detail below in conjunction with the basic procedure diagram shown in FIG. 1.

As shown in FIG. 1, in Embodiment 1 of the present invention, the steps performed by the user equipment include the following:

In step S101, a higher layer (or an upper layer) requests (or triggers) sidelink user equipment (a physical layer) to determine a resource subset for a PSSCH/PSCCH transmission.

The higher layer selects, from the resource subset, a sidelink resource for the PSSCH/PSCCH transmission.

Optionally, the higher layer requests, in a slot n, the user equipment to determine the resource subset for the PSSCH/PSCCH transmission.

Optionally, the sidelink user equipment is sidelink user equipment equipped with both an LTE sidelink module and an NR sidelink module.

In step S102, the sidelink user equipment determines a candidate resource set S_{A}.

Optionally, the candidate resource set S_{A} represents candidate resources in a resource selection window [n+T₁, n+T₂].

In step S103, the sidelink user equipment excludes one or more candidate resources from the candidate resource set S_{A}.

Optionally, the user equipment excludes one or more candidate resources from the candidate resource set based on a parameter Q. Optionally, the parameter Q represents the number of SCIs that the user equipment assumes to receive (in the resource selection window) and that are the same as SCIs received (by the LTE sidelink module) on a subframe

$${t}_{m}^{SL} .$$

Optionally, if P_{rsvp_RX}×Pₛₜₑₚ<T₂ and n′−m≤Pₛₜₑₚ×P_{rsvp_RX}, then Q=┌T₂/(P_{rsvp_RX}×Pₛₜₑₚ); otherwise, Q=1·P_{rsvp_RX} represents a resource reservation interval indicated in the SCIs received (by the LTE sidelink module) on the subframe

$${t}_{m}^{SL} .$$

It the slot n belongs to a resource pool or a slot set

$$( {t}_{0}^{SL} , {t}_{1}^{SL} , … , {t}_{{T}_{max}}^{SL} ) ,$$

then

$${t}_{{n}^{′}}^{SL} = n ;$$

otherwise

$${t}_{{n}^{′}}^{SL}$$

represents the first subframe following the slot n that belongs to the subframe set

$$( {t}_{0}^{SL} , {t}_{1}^{SL} , … , {t}_{{T}_{max}}^{SL} )$$

or the resource pool.

Optionally, the LTE sidelink module of the sidelink user equipment indicates (or shares) information associated with the SCIs to the NR sidelink module, including but not limited to: the SCIs received by the LTE sidelink module on the subframe

$${t}_{m}^{SL} ,$$

and/or the resource reservation period P_{rsvp_RX}, and/or TDD configuration information of LTE sidelink.

Optionally, the user equipment excluding one or more candidate resources from the candidate resource set based on a parameter Q further includes: at least satisfying that, if resource blocks and subframe resources indicated in the SCIs received by the LTE sidelink module on the subframe

$${t}_{m}^{SL}$$

or the same SCIs assumed to be received on the subframe

$${t}_{m + q \times {P}_{step} \times {P}_{rsvp \_ RX}}^{SL}$$

(optionally, the user equipment assuming that a time gap between an initial transmission and a retransmission is equal to 0) overlap with a candidate single subframe resource

$${R}_{x , y + j \times {P}_{{rsvp \_ TX}^{′}}} ,$$

the user equipment excludes the candidate single subframe resource R_{x,y} from S_{A}. q=1, 2, . . . , Q, and j=1, 2, . . . , Cᵣₑₛₑₗ−1. P_{rsvp_TX′}=P_{rsvp_TX}×Pₛₜₑₚ/100 or

$${P}_{{rsvp \_ TX}^{′}} = ⌈ \frac{{T}_{max}^{′}}{10240 ms} \times {P}_{rsvp \_ TX} ⌉ .$$

P_{rsvp_TX} represents a resource reservation period sent by the user equipment

$${T}_{max}^{′}$$

represents the number of slots (or subframes) in the resource pool within 10240 ms (SFN or DFN 0-1023).

FIG. 2 is a block diagram showing user equipment (UE) according to the present invention. As shown in FIG. 2, the user equipment (UE) 80 includes a processor 801 and a memory 802. The processor 801 may include, e.g., a microprocessor, a microcontroller, an embedded processor, etc. The memory 802 may, for example, include a volatile memory (e.g., a random access memory (RAM)), a hard disk drive (HDD), a non-volatile memory (e.g., a flash memory), or other memories. The memory 802 has program instructions stored thereon. The instructions, when run by the processor 801, can perform the method performed by user equipment described in detail in the present invention.

The method and related equipment according to the present invention have been described above in combination with preferred embodiments. It should be understood by those skilled in the art that the method shown above is only exemplary, and the above-described embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an MME, or UE, and the like. Various identifiers illustrated above are only exemplary, and are not meant to be limiting. The present invention is not limited to specific information elements serving as examples of these identifiers. Those skilled in the art could make various alterations and modifications according to the teachings of the illustrated embodiments.

It should be understood that the above-described embodiments of the present invention may be implemented by software, hardware, or a combination of software and hardware. For example, various components in the base station and user equipment in the above embodiments can be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present application, the “base station” may refer to a mobile communication data and control exchange center having large transmission power and a wide coverage area, including functions such as resource allocation and scheduling and data reception and transmission. The term “user equipment” may refer to user mobile terminals, such as terminal devices that can wirelessly communicate with a base station or a micro base station, including a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic enables the processor to execute the operations (methods) described in the embodiments of the present invention. Such an arrangement of the present invention is typically provided as software, code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database and so on in one or more modules. Software or firmware or such configuration may be installed on a computing device such that one or more processors in the computing device performs the technical solutions described in the embodiments of the present invention.

In addition, each functional module or each feature of the base station device and the terminal device used in each of the above embodiments may be implemented or executed by circuits, which are usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor, or the processor may be an existing processor, a controller, a microcontroller, or a state machine. The aforementioned general-purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-3. (canceled)

4: A user equipment (UE), comprising:
a processor; and
a memory storing instructions,
wherein the processor is configured by the instructions to cause the UE to:
receive first Sidelink Control Information (SCI) indicating a resource reservation interval P_{rsvp RX} in a subframe;
determine a subset of sidelink (SL) resources by excluding one or more candidate resources based on at least a number of one or more second SCIs that are assumed to be received and that are same as the first SCI;
determine a parameter Q, which represents the number of one or more second SCI, based on at least a parameter Pₛₜₑₚ, the resource reservation interval P_{rsvp RX}, and a parameter T₂, wherein the parameter T₂ is a parameter for defining a resource selection window, and the parameter Pₛₜₑₚ represents a number of uplink subframes within 100 ms for an LTE UL/DL configuration; and
select one or more resources for a Physical Sidelink Shared Channel (PSSCH)/Physical Sidelink Control Channel (PSCCH) transmission from the subset of the SL resources.

5: A method performed by a user equipment (UE), the method comprising:
receiving first Sidelink Control Information (SCI) indicating a resource reservation interval P_{rsvp RX} in a subframe;
determining a subset of sidelink (SL) resources by excluding one or more candidate resources based on at least a number of one or more second SCIs that are assumed to be received and that are same as the first SCI;
determining a parameter Q, which represents the number of one or more second SCI, based on at least a parameter Pₛₜₑₚ, the resource reservation interval P_{rsvp RX}, and a parameter T₂, wherein the parameter T₂ is a parameter for defining a resource selection window, and the parameter Pₛₜₑₚ represents a number of uplink subframes within 100 ms for an LTE UL/DL configuration; and
selecting one or more resources for a Physical Sidelink Shared Channel (PSSCH)/Physical Sidelink Control Channel (PSCCH) transmission from the subset of the SL resources.
